(19) United States
(12) Patent Application Publication
(10) Pub. No.: US 2009/0139363 A1
(43) Pub. Date: Jun. 4, 2009

(54) CONTINUOUS VARIABLE VALVE LIFT APPARATUS

(76) Inventors: Young Hong Kwak, Suwon city (KR); Ki Uk Shin, Hwaseong-city (KR)

Correspondence Address: MORGAN, LEWIS & BOCKIUS LLP (SF), One Market, Spear Street Tower, Suite 2800, San Francisco, CA, 94105, US

(21) Appl. No.: 11/966,691

(22) Filed: Dec. 28, 2007

(30) Foreign Application Priority Data
Nov. 30, 2007 (KR) 10-2007-0123829

(51) Int. Cl. G05G 11/00

(52) U.S. Cl. 74/479.01

(57) ABSTRACT

A continuous variable valve lift apparatus includes an input cam; a control lever rotating shaft; a control lever with a contact portion, provided on the control lever rotating shaft; a control portion that controls the angle between the control lever and the control lever rotating shaft; a first link rotatably connected to the control lever rotating shaft; a second link rotatably connected to the first link, that contacts the contact portion; an output cam on the second link, to open and close a valve; and an elastic portion provided such that a connecting portion of the first link and the second link contact the input cam.

### CROSS-REFERENCE TO RELATED APPLICATION

This application claims priority to and the benefit of Korean Patent Application No. 10-2007-0123829 filed in the Korean Intellectual Property Office on Nov. 30, 2007, the entire contents of which are incorporated herein by reference.

### BACKGROUND OF THE INVENTION

(a) Field of the Invention

The present invention relates to a continuous variable valve lift apparatus.

(b) Description of the Related Art

A typical combustion chamber of an automotive engine is provided with an intake valve for supplying the air/fuel mixture and an exhaust valve for expelling the burned gas. The intake and exhaust valves are opened and closed by a valve lift apparatus connected to a crankshaft.

A conventional valve lift apparatus has a fixed valve lift amount due to a fixed cam shape. Therefore, it is impossible to adjust the amount of a gas that is being introduced or exhausted.

If the valve lift apparatus is designed for low driving speeds, the valve open time and amount are not sufficient for high speeds. On the other hand, if the valve lift apparatus is designed for high speeds, the opposite is true.

The above information disclosed in this Background section is only for enhancement of understanding of the background of the invention and therefore it may contain information that does not form the prior art that is already known in this country to a person of ordinary skill in the art.

### SUMMARY OP THE INVENTION

A continuous variable valve lift apparatus includes an input cam; a control lever rotating shaft; a control lever with a contact portion, provided on the control lever rotating shaft; a control portion that controls the angle between the control lever and the control lever rotating shaft; a first link rotatably connected to the control lever rotating shaft; a second link rotatably connected to the first link, that contacts the contact portion; an output cam on the second link, to open and close a valve; and an elastic portion provided such that a connecting portion of the first link and the second link contact the input cam.

A first roller may be provided on the connecting portion of the first link and the second link. A second roller may be provided on the second link for contacting the contact portion.

### BRIEF DESCRIPTION OF THE DRAWINGS

FIG. 1 is a front view of a continuous variable valve lilt apparatus according to an exemplary embodiment of the present invention.

FIG. 2 is a perspective view of the apparatus of FIG. 1.

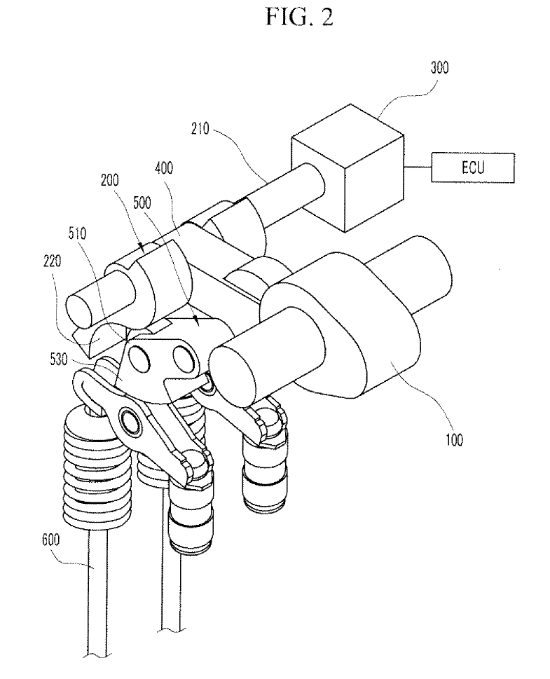

FIG. 3 is a side view of the apparatus of FIG. 1.

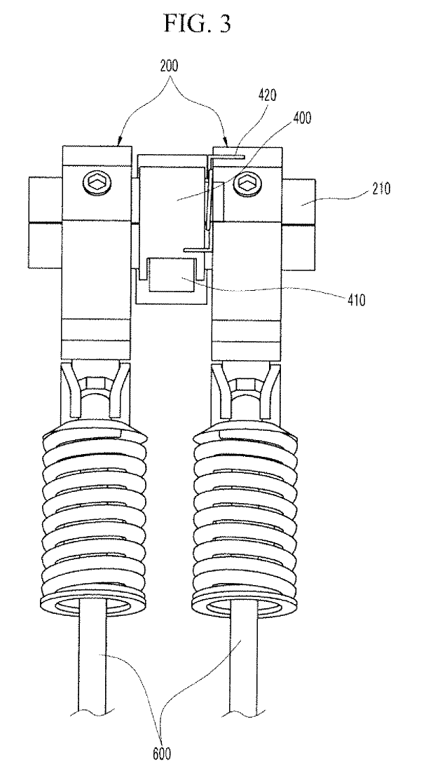

### DESCRIPTION OF REFERENCE NUMERALS INDICATING ELEMENTS IN THE DRAWINGS

| | |
|---|---|
| 100: input cam | 200: control lever |
| 210: control lever rotating shaft | 220: contact portion |
| 300: control portion | 400: first link |
| 410: first bearing | 420: elastic portion |
| 500: second link | 510: second bearing |
| 530: output cam | 600: valve |

### DETAILED DESCRIPTION OF PREFERRED EMBODIMENTS

An exemplary embodiment of the present invention will hereinafter be described in detail with reference to the accompanying drawings.

An input cam 100 transmits rotation. A control lever rotating shaft 210 is connected to a control portion 300. A control lever 200 is provided on the control lever rotating shaft 210, and has a contact portion 220.

A first link 400 is rotatably connected to the control lever rotating shaft 210. A second link 500 is rotatably connected to the first link 400, and contacts the contact portion 220. An output cam 530 is disposed on the second link 500 for opening and closing a valve 600.

An elastic portion 420 is provided on the control lever rotating shaft 210 such that a connecting portion of the first link 400 and the second link 500 contact the input cam 100.

A first roller 410 is provided on the connecting portion of the first link 400 and the second link 500, and a second roller 510 is provided on the second link 500 for contacting with the contact portion 220.

Rotation of the input cam 100 is smooth due to the first roller 410 and the second roller 510.

Hereinafter, mode changing of the continuous variable valve lift apparatus according to an exemplary embodiment of the present invention will be explained.

An electronic control unit (ECU, not shown) determines operation conditions of a vehicle, and controls the control portion 300 so that the control lever 200 can turn the control lever rotating shaft 210. The ECU may include a processor, memory, and associated hardware, software, and/or firmware as may be selected and programmed by a person of ordinary skill in the art based on the teachings herein.

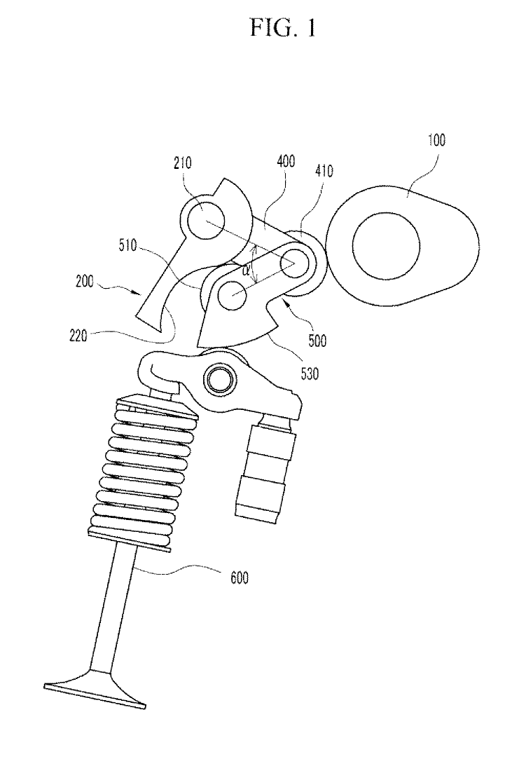

In FIG. 1, if the control lever 200 rotates clockwise around the control lever rotating shaft 210, the relative angle a between the control lever rotating shaft 210, the first roller 410, and the second roller 510 is relatively reduced, and valve lift amounts and timing of the valve 600 are reduced.

However, if the control lever rotates counter-clockwise around the control lever rotating shaft 210, a is relatively increased and valve lift amounts and timing of the valve 600 are increased.

Thus, the continuous variable valve lift apparatus according to the exemplary embodiment of the present invention can modify valve lift according to control of the relative angle of the control lever 210.

The contact portion 200 is illustrated with an S-shaped cross-section, but the cross-section can be designed according to required lift change, positions of each link, and so on, and a cylinder deactivation (CDA) mode can be achieved with various shapes of the contact portion 220 and the output cam 530.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A continuous variable valve lift apparatus, comprising:
an input cam;
a control lever rotating shaft:
a control lever that comprises a contact portion and is disposed on the control lever rotating shaft;
a control portion that controls an angle between the control lever and the control lever rotating shaft;
a first link that is rotatably connected to the control lever rotating shaft;
a second link that is rotatably connected to the first link and contacts the contact portion;
an output cam that is disposed on the second link and configured to open and close a valve; and
an elastic portion disposed such that a connecting portion of the first link and the second link contact the input cam.

2. The continuous variable valve lift apparatus of claim 1, further comprising a roller disposed on the connecting portion of the first link and the second link.

3. The continuous variable valve lift apparatus of claim 1, further comprising a roller disposed on the second link for contacting the contact portion.
